(19) United States
(12) Patent Application Publication
(10) Pub. No.: US 2010/0172065 A1
(43) Pub. Date: Jul. 8, 2010

(54) CAPACITOR STRUCTURE

(76) Inventors: Tsai-Yu Huang, Taipei County (TW); Shin-Yu Nieh, Taipei City (TW); Hui-Lan Chang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/399,020

(22) Filed: Mar. 6, 2009

(30) Foreign Application Priority Data
Jan. 5, 2009 (TW) 098100096

(51) Int. Cl. H01G 4/20

(52) U.S. Cl. 361/313

(57) ABSTRACT

A capacitor structure includes: a top electrode, a bottom electrode, a first capacitor dielectric layer positioned between the top electrode and the bottom electrode and a second capacitor dielectric layer positioned between the top electrode and the bottom electrode. The first capacitor dielectric layer is selected from the group consisting HfO₂, ZrO₂, and TiO₂. The second capacitor dielectric layer is selected from the group consisting of lanthanide oxide series and rare earth oxide series.

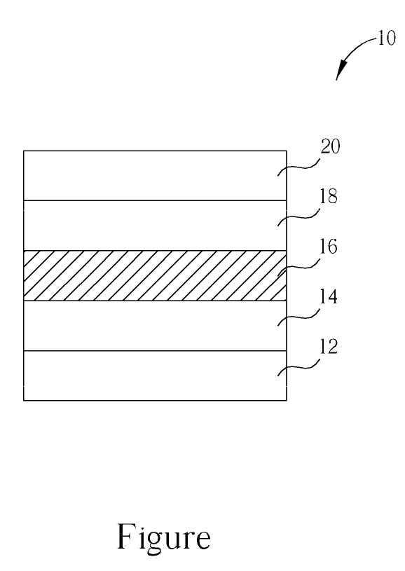

### BACKGROUND OF THE INVENTION

1. Field of the Invention

The present invention relates to a capacitor structure, and more particularly, to a capacitor structure with multiple capacitor dielectric layers.

2. Description of the Prior Art

The metal-insulator-metal (MIM) capacitor is commonly used in the semiconductor field because the fabricating process of an MIM capacitor can be integrated with the interconnect process. However, as the complexity and integration of integrated circuits continues to increase, the size of semiconductor elements becomes smaller and smaller. The metal-insulator-metal (MIM) capacitor is commonly used in the semiconductor field because the fabricating process of an MIM capacitor can be integrated with the interconnect process. However, as the complexity and integration of integrated circuits continues to increase, the size of semiconductor elements becomes smaller and smaller. This has led to a reduction in the overall size of capacitors with the result that the corresponding capacitance is also reduced. Therefore, it is important to find out effective ways to improve the capacitance through circuit design.

Using a dielectric material with a high dielectric constant in the capacitor dielectric layer is one effective way to increase capacitance. According to conventional methods, silicon dioxide-nitride-dioxide (ONO) or aluminum oxide (Al₂O₃) is utilized as the capacitor dielectric layer. To improve the capacitance, some of the MIMs use materials with high dielectric constants as dielectric layers: for example, zirconium oxide (ZrO₂), tantalum oxide (Ta₂O₅), tantalum oxynitride (TaON), barium strontium titanate (BaSrTiO₃ ,BST), lead zirconium titanate (PZT) or hafnium oxide (HfO₂).

Although a material with a high dielectric constant can provide high capacitance for a capacitor, current leakage may occur. Therefore, a novel capacitor structure which can improve capacitance and prevent current leakage is needed.

### SUMMARY OF THE INVENTION

It is one objective of the present invention to provide a capacitor structure with multiple dielectric layers to increase capacitance and prevent current leakage.

According to a preferred embodiment of the present invention, a capacitor structure comprises: a top electrode; a bottom electrode; a first capacitor dielectric layer selected from the group consisting of HfO₂, ZrO₂ and TiO₂, positioned between the top electrode and the bottom electrode; and a second capacitor dielectric layer selected from the group consisting of lanthanide oxide series and rare earth oxide series, positioned between the top electrode and the bottom electrode.

According to another preferred embodiment of the present invention, a capacitor structure comprises: a top electrode; a bottom electrode; a first capacitor dielectric layer consisting essentially of Al₂O₃, positioned between the top electrode and the bottom electrode; a third capacitor dielectric layer selected from the group consisting of HfO₂, ZrO₂, lanthanide oxide series and rare earth oxide series, positioned between the top electrode and the bottom electrode; and a second capacitor dielectric layer selected from the group consisting of titanium oxide (TiO₂), strontium titanate (SrTiO₃,STO) and BaSrTiO₃, positioned between the first capacitor dielectric layer and the third capacitor dielectric layer.

Lanthanide oxide series and rare earth oxide series are utilized as the capacitor dielectric layer because of their high energy gaps and high dielectric constants. In this way, the current leakage can be blocked by lanthanide oxide series and rare earth oxide series, and the capacitance can also be increased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGURE is a schematic diagram depicting a capacitor structure according to a preferred embodiment of the present invention.

### DETAILED DESCRIPTION

The FIGURE is a schematic diagram depicting a capacitor structure according to a preferred embodiment of the present invention. As shown in the FIGURE, a capacitor structure 10 includes a bottom electrode 12, a first capacitor dielectric layer 14, a second capacitor dielectric layer 16, a third capacitor dielectric layer 18 and a top electrode 20 disposed from bottom to top, respectively. The FIGURE is a schematic diagram depicting a capacitor structure according to a preferred embodiment of the present invention. As shown in the FIGURE, a capacitor structure 10 includes a bottom electrode 12, a first capacitor dielectric layer 14, a second capacitor dielectric layer 16, a third capacitor dielectric layer 18 and a top electrode 20 disposed from bottom to top, respectively. The first capacitor dielectric layer 14 includes materials selected from the group consisting of HfO₂, ZrO₂ and TiO₂. The second capacitor dielectric layer 16 includes at least one material selected from the group consisting of lanthanide oxide series and rare earth oxide series, such as yttrium oxide (Y₂O₃), scandium oxide (Sc₂O₃), and erbium oxide (Er₂O₃). The third capacitor dielectric layer 18 includes at least one material selected from the group consisting of HfO₂, ZrO₂ and TiO₂. The top electrode 20 and the bottom electrode 20 includes at least one material selected from the group consisting of titanium nitride (TiN), ruthenium (Ru), platinum (Pt), tungsten nitride (WN), iridium (Ir), ruthenium oxide (RuO₂), strontium ruthenium oxide (SrRuO) and other conductive materials. According to a preferred embodiment of the present invention, materials with high work function are preferred, because materials with high work function have better performance in preventing current leakage.

The materials of the first capacitor dielectric layer 14 and the third capacitor dielectric layer 18 are preferably crystallized, such as crystallized HfO₂, crystallized ZrO₂ and crystallized TiO₂. In this way, the first capacitor dielectric layer 14 and the third capacitor dielectric layer 18 of the capacitor structure 10 will have high dielectric constants to increase the capacitance. Moreover, it is noteworthy that the second capacitor dielectric layer 16 is for preventing current leakage. Therefore, the material of the second capacitor dielectric layer 16 is preferably amorphous, such as amorphous lanthanide oxide series and amorphous rare earth oxide series, since amorphous lanthanide oxide series and amorphous rare earth oxide series have better performance in current leakage prevention than that of crystallized lanthanide oxide series and crystallized rare earth oxide series. Furthermore, the lanthanide oxide series and the rare earth oxide series have larger energy gaps than that of Al₂O₃. In addition, the dielectric constants of lanthanide oxide series and rare earth oxide series are between 20 and 25; the dielectric constants of Al₂O₃ are between 9 and 10. Therefore, it is noteworthy that utilizing lanthanide oxide series and rare earth oxide series as the capacitor dielectric layer not only can prevent current leakage but can also increase the capacitance.

According to another preferred embodiment of the present invention, the third dielectric layer 18 described above can be disposed optionally. Furthermore, the positions of the first dielectric layer 14 and the second dielectric layer 16 can be exchanged.

Another capacitor structure according to another preferred embodiment of the present invention is provided. For simplicity, the FIGURE will be used to exemplify the following description. As shown in the FIGURE, a capacitor structure 10 includes a bottom electrode 12, a first capacitor dielectric layer 14, a second capacitor dielectric layer 16, a third capacitor dielectric layer 18 and a top electrode 20 disposed from bottom to top, respectively. The first capacitor dielectric layer 14 includes Al₂O₃ (preferably amorphous Al₂O₃). The second capacitor dielectric layer 16 includes at least one material selected from the group consisting of TiO₂, SrTiO₃, BaSrTiO₃ and other highly conductive materials. The third capacitor dielectric layer 18 includes at least one material selected from the group consisting of HfO₂, ZrO₂, lanthanide oxide series and rare earth oxide series; more preferably, amorphous HfO₂, amorphous ZrO₂, amorphous lanthanide oxide series and amorphous rare earth oxide series. The top electrode 20 and the bottom electrode 12 include TiN, Ru, Pt, WN, Ir, RuO₂, SrRuO or other conductive materials. The main purpose of the second dielectric layer 16 is to provide a high dielectric constant for the capacitor 10. In addition, the first dielectric layer 14 and the third dielectric layer 18 are for current leakage prevention.

According to the conventional capacitor structure, a single layer of TiN, SrTiO₃, or BaSrTiO₃ is used as a capacitor dielectric layer to provide high capacitance. However, current leakage may occur. Moreover, a problem occurs in surface affinity between the capacitor dielectric layer and the top or bottom electrode in the conventional capacitor.

Compared to the conventional capacitor, the capacitor structure 10 has the first dielectric layer 14 and the third dielectric layer 18 to prevent current leakage and to further increase the capacitance of the capacitor structure 10. In addition, the first capacitor dielectric layer 14 and the third dielectric layer 18 of the present invention can also serve as barriers between the top/bottom electrode and the capacitor dielectric layer with high dielectric constants, such as the second capacitor dielectric layer 16, to provide better surface affinity between the electrodes and the capacitor dielectric layers.

Although only planar-type capacitors are illustrated above, the spirit of the present invention can also be applied to capacitors with different designs such as cylinder-type capacitors or pedestal-type capacitors.

The fabricating method of the capacitor structure according to a first preferred embodiment is illustrated as follows:

As shown in the FIGURE, a bottom electrode 12, a first capacitor dielectric layer 14, a second capacitor dielectric layer 16, a third capacitor dielectric layer 18 and a top electrode 20 are formed by the atomic layer deposition (ALD) sequentially. The positions of the first capacitor dielectric layer 14, the second capacitor dielectric layer 16 and the third capacitor dielectric layer 18 can be changed with one another. Next, an anneal process is performed to the bottom electrode 12, the first capacitor dielectric layer 14, the second capacitor dielectric layer 16, the third capacitor dielectric layer 18 and the top electrode 20. The temperature of the anneal process is between 300 and 650° C. and the operation time of the anneal process is between 2 and 90 minutes. The anneal process can be replaced by a rapid thermal process (RTP). The temperature of the RTP is between 350 and 650° C., and the operation time of the RTP is between 30 and 120 seconds. After the anneal process, the first capacitor dielectric layer 14 and the third capacitor dielectric layer 18 are crystallized and the second dielectric layer 16 is still amorphous. The anneal process of the capacitor structure can be preformed along with other semiconductor processes. At this point, the capacitor structure 10 of the first preferred embodiment of the present invention is completed. The ALD mentioned above can be replaced by the metal-organic CVD. The ALD is more suitable for capacitor structures with high step coverage, and the metal-organic CVD is more suitable for planar-type capacitors.

The fabricating method of the capacitor structure according to a second preferred embodiment is illustrated as follows:

As shown in the FIGURE, a bottom electrode 12, a first capacitor dielectric layer 14, a second capacitor dielectric layer 16, a third capacitor dielectric layer 18 and a top electrode 20 are formed by the atomic layer deposition (ALD) or the metal-organic CVD sequentially. Next, an anneal process is performed to the bottom electrode 12, the first capacitor dielectric layer 14, the second capacitor dielectric layer 16, the third capacitor dielectric layer 18 and the top electrode 20. The temperature of the anneal process is between 300 and 650° C. and the operation time of the anneal process is between 2 and 90 minutes. The anneal process can be replaced by a rapid thermal process (RTP). The temperature of the RTP is between 350 and 650° C., and the operation time of the RTP is between 30 and 120 seconds. In this way, the second capacitor dielectric layer 16 is crystallized, and the first capacitor dielectric layer 14 and the third capacitor dielectric layer 18 are still amorphous.

Those skilled in the art will readily observe that numerous modifications and alterations of the device and method may be made while retaining the teachings of the invention.

What is claimed is:

1. A capacitor structure, comprising:
a top electrode;
a bottom electrode;
a first capacitor dielectric layer selected from the group consisting of HfO₂, ZrO₂ and TiO₂, the first capacitor dielectric layer being positioned between the top electrode and the bottom electrode; and
a second capacitor dielectric layer selected from the group consisting of lanthanide oxide series and rare earth oxide series, the second capacitor dielectric layer being positioned between the top electrode and the bottom electrode.

2. The capacitor structure of claim 1, further comprising a third capacitor dielectric layer selected from the group consisting of HfO₂, ZrO₂ and TiO₂, the third capacitor dielectric layer being positioned between the top electrode and the bottom electrode.

3. The capacitor structure of claim 2, wherein the third capacitor dielectric layer is crystallized.

4. The capacitor structure of claim 1, wherein the first capacitor dielectric layer is crystallized.

5. The capacitor structure of claim 1, wherein the second capacitor dielectric layer is selected from the group consisting of Y₂O₃, Sc₂O₃, and Er₂O₃.

6. The capacitor structure of claim 1, wherein the second capacitor dielectric layer is amorphous.

7. The capacitor structure of claim 1, wherein the top electrode and the bottom electrode are both selected from the group consisting of TiN, Ru, Pt, WN, Ir, RuO₂, and SrRuO.

8. A capacitor structure, comprising:
a top electrode;
a bottom electrode;
a first capacitor dielectric layer consisting essentially of Al₂O₃, the first dielectric layer being positioned between the top electrode and the bottom electrode;
a third capacitor dielectric layer selected from the group consisting of HfO₂, ZrO₂, lanthanide oxide series and rare earth oxide series, the third capacitor dielectric layer being positioned between the top electrode and the bottom electrode; and
a second capacitor dielectric layer selected from the group consisting of TiO₂, SrTiO₃ and BaSrTiO₃ the second capacitor dielectric layer being positioned between the first capacitor dielectric layer and the third capacitor dielectric layer.

9. The capacitor structure of claim 8, wherein the top electrode and the bottom electrode are both selected from the group consisting of TiN, Ru, Pt, WN, Ir, RuO₂, and SrRuO.

10. The capacitor structure of claim 8, wherein the first capacitor dielectric layer is amorphous.

11. The capacitor structure of claim 8, wherein the third capacitor dielectric layer is amorphous.
